(19) United States
(12) Patent Application Publication
(10) Pub. No.: US 2010/0135857 A1
(43) Pub. Date: Jun. 3, 2010

(54) PORTABLE DEVICE FOR READING A FLUORESCENT-LABELLED, MEMBRANE BASED ASSAY

(75) Inventors: William Samuel Hunter, Jan Juc (AU); William Robb Hopper, Ivanhoe East (AU)

Correspondence Address: CALFEE HALTER & GRISWOLD, LLP, 800 SUPERIOR AVENUE, SUITE 1400, CLEVELAND, OH, 44114, US

(73) Assignee: Fluidyx Pt ltd

(21) Appl. No.: 12/598,274

(22) PCT Filed: May 2, 2008
(86) PCT No.: PCT/AU2008/000622

§ 371 Date: Feb. 19, 2010

(30) Foreign Application Priority Data
May 2, 2007 (AU) 2007902296
Sep. 20, 2007 (AU) 2007905149

(51) Int. Cl. G01N 21/64

(52) U.S. Cl. 422/82.08

(57) ABSTRACT

The invention concerns a portable device for reading a fluorescent-labelled, membrane based assay, to detect the presence of an analyte in a sample. The portable device comprises a light sealed housing which includes a receiving member to receive a membrane based assay. The light sealed housing comprises a first light source for illuminating a first portion of the membrane with light, a first photodetector, a light guide and a microprocessor. The first photodetector is operable to detect fluoresced light emitted by an excited fluorescent label captured by a reagent laid down in the first portion of the membrane and to measure an intensity of the fluoresced light. The light guide guides illuminated light from the first light source to the first portion of the membrane and guides fluoresced light emitted by the excited fluorescent label to the first photodetector. The microprocessor is operable to process the measured intensity of the fluoresced light to determine whether the analyte is present.

### CROSS-REFERENCE TO RELATED APPLICATIONS

The present application claims priority from Australian Provisional Patent Application No 2007902296 filed on 2 May 2007, and Australian Provisional Patent Application No 2007905149 filed on 20 Sep. 2007, the contents each of which are incorporated herein by reference.

### FIELD OF THE INVENTION

This invention relates to a portable device for reading a fluorescent-labelled, membrane based assay, to detect the presence and/or quantity of an analyte in a sample. The invention further relates to a portable device for scanning a fluorescent-labelled, membrane based assay, to detect the presence and/or quantity of an analyte in a sample.

### BACKGROUND OF THE INVENTION

Present methods for the diagnosis of many medical conditions based on immunoassay include two different classes of test. At the one end of the spectrum, tests are conducted off-site in clinical pathology laboratories. Such laboratories often use complex and expensive instrumentation requiring expensive reagents and highly trained technicians. Instrumentation may include, for example, high throughput clinical chemistry analysers based on ELISA (Enzyme Linked Immunoabsorbent Assay) and other techniques.

A significant problem with the use of centralized clinical pathology testing is the delay in obtaining the results of such tests, and in the case of infectious diseases, such delays can be potentially hazardous to the patient's wellbeing as well as posing unacceptable risks to others in the community.

There are certain tests, for example influenza, and many sexually transmitted diseases where the clinician ideally requires immediate or very rapid test results to be obtained. In remote locations, there may not be a clinical pathology infrastructure near to the point of testing, and once again, delays in obtaining test results in such circumstances could be life-threatening.

Rapid tests are available for many medical conditions which may be procured at low cost. These tests are typically referred to as lateral flow tests, also known as lateral flow assays, membrane based assays, and lateral immunochromatographic tests.

Such tests are traditionally composed of a variety of materials overlapping onto one another and mounted on a backing strip. When a test is run, a sample containing a suspected antigen is added to a sample application pad. The sample migrates to a conjugate pad, where a particulate conjugate—the target, has been immobilized. The particle is conjugated to one of the specific biological components of the assay, either antigen or antibody. The sample remobilizes the conjugate, and the analyte in the sample interacts with the conjugate as both migrate along a porous membrane. A capture reagent, having been laid down in a strip on the membrane, serves to capture the analyte and conjugate as they migrate past.

The first immunoassays were performed in the late 1950s. They were classified as radioimmunoassays and used an isotope whose high sensitivity increases with test time, as a label. To perform these types of tests, scintillators and protective equipment were required. As a result, on-site testing was not feasible.

In the 1980s, enzyme labels emerged and alkaline phosphatase labels were used because the colour produced by substrate conversion can be detected visually. Results were interpreted as the presence or absence of a visible line of captured conjugate. However, the results are usually difficult to quantify.

Whilst such tests offer rapid results, a problem with lateral flow tests is that a significant amount of the antigen or antibody must be present in the sample analyte in order for the development of a visible line. Subsequently these types of tests have a poor degree of sensitivity resulting in a substantial number of false negative results, especially when a patient is in the early stages of an infection, and when the amount of a particular antigen, antibody or viral load in a patient may be low. Moreover, it is in the early stages of detection that it is important that diagnosis is correctly performed in order to administer an appropriate therapeutic to the patient, or to quarantine the patient to prevent the further spread of the infectious disease to the remainder of the community.

To address this problem some manufacturers have developed lateral flow tests that employ fluorescent labels to facilitate the detection of an analyte along with appropriate readers. Although these labelling techniques can yield several orders of magnitude increase in sensitivity improvement relative to previous techniques, the complex and often expensive detection equipment required has limited the market for such tests. The high-cost of such readers detracts from the main benefit of lateral flow testing, which is that it is based on a very cheap, robust, and easy to use test which is compact enough to be carried anywhere (for example, in a shirt or coat pocket).

For example, in remote locations, there may not be a clinical pathology infrastructure near to the point of testing, and once again delays in obtaining accurate test results in such circumstances could be life-threatening. In these circumstances, a lab-bench based instrument is not appropriate.

### SUMMARY OF THE INVENTION

In a first broad aspect, the present invention is a portable device for reading a fluorescent-labelled, membrane based assay, to detect the presence of an analyte in a sample, the portable device comprising:

a light sealed housing comprising a receiving member to receive a membrane based assay, the light sealed housing including:
a first light source for illuminating a first portion of a membrane with light;
a first photodetector for detecting fluoresced light emitted by an excited fluorescent label captured by a reagent laid down in the first portion of the membrane and for measuring an intensity of the fluoresced light;
a light guide for guiding illuminated light from the first light source to the first portion of the membrane and for guiding fluoresced light emitted by the excited fluorescent label to the first photodetector; and
a microprocessor operable to process the measured intensity of the fluoresced light to determine whether an analyte is present.

The first light source may be an incoherent light source, or a coherent light source. The light source may be a solid state light source. The solid state light source may be a light emitting diode, such as an ultra-violet light emitting diode, or a laser diode. Other light sources such as incandescent light sources may be used although light emitting diodes, laser diodes, or other like light sources are preferable due to their compactness and fast response times.

Preferably the first light source is operable to emit light which is substantially matched to the optimum excitation wavelength band for the fluorescent label. The fluorescent label may be one of a fluorescent molecule, dendrimer and particle. The fluorescent label may include a lanthanide chelate of europium, samarium, terbium, dysprosium or a combination thereof. Optionally, the fluorescent label may be any other fluorescent marker suitable for immunoassay. Preferably the fluorescent label has an emission lifetime of greater than about 10 microseconds.

In a non-limiting embodiment where the fluorescent label is a lanthanide chelate, the light emitting diode, or laser diode, may be operable to emit light in the range of 340 nm to 390 nm. Optionally, the light emitting diode, or laser diode, may be operable to emit light in the range of 340 nm to 365 nm. More preferably the light emitting diode, or laser diode, may be operable to emit light in the range of 350 nm to 360 nm.

The first photodetector may be one of a photodiode, for instance a silicon photodiode, a silicon photomultiplier device, a charged coupled device array and a CMOS array. Preferably the first photodetector has a peak sensitivity in a range which is substantially matched to the optimum band for detection of the fluoresced light emitted by the excited fluorescent label.

The portable device may include a memory in communication with the microprocessor to store diagnostic results of an assay. The microprocessor may operate to store diagnostic results of an assay together with an identifier. The identifier may comprise a date and time stamp.

The portable device may include a data communication module to enable data communication with a remote device and to upload data from the memory and/or to download firmware from a remote device. The remote device may be an external computing device, web server, or the like. The data communication module may include a USB interface through which data communication with an external computing device may be effected. Optionally, or in addition, a radio frequency transmitter, or transceiver, may be disposed within the device housing, the transmitter in data communication with the memory and remotely operable to transmit data to an external computing device. The radio transmitter/transceiver may utilise Bluetooth technology, or any like standard in wireless communication which enables communication between the portable device and an external device.

In an embodiment where a membrane is tagged with a membrane identifier, the portable device may include a membrane identifier reader in data communication with the microprocessor. For instance, where the membrane identifier is one of a radio frequency tag, a magnetic readable strip or a barcode, the membrane identifier reader may be in the form of a radio frequency reader, a magnetic strip reader or a barcode reader respectively.

The portable device may include a GPS transmitter in communication with the microprocessor.

The portable device may include a power supply housed within the housing to supply electrical current to electrical components of the device. The power supply is preferably a rechargeable power supply such as, but not limited to, rechargeable batteries. In an embodiment where the portable device includes a USB interface, the USB interface may provide the means to recharge the rechargeable power supply.

In a first embodiment, a single light guide may guide illuminated light from the first light source to the first portion of the membrane and guide fluoresced light emitted by the excited fluorescent label to the first photodetector. In such an embodiment the light source may be a pulsed light source and the first photodetector may be a time gated photodetector. The microprocessor may include, or operate in conjunction with, timing circuitry in communication with the first light source and the time-gated detector, to control pulsed excitation and detection. The microprocessor and timing circuitry may be operable to:

(i) direct the first light source to turn on;

(ii) direct the first light source to turn off after a first time period; and

(iii) measure the intensity of the fluoresced light after a second time period measured from when the light source is directed to turn off.

The microprocessor and timing circuitry may be further operable to repeat (i) to (iii) for a certain number of times and to average the results. This procedure is referred to hereon as time-gated fluorescence.

In the first embodiment, the portable device may comprise a second light source for illuminating a second portion of a membrane, downstream from the first portion of the membrane, and a second photodetector for detecting fluoresced light emitted by an excited fluorescent label captured by a second reagent laid down in the second portion of the membrane. In such an example of the first embodiment, the second portion of the membrane may act as a control zone which indicates to a user that the assay is performing properly, that is, that mobilisation of the label and migration through the membrane have occurred. The second light source may be the same light source as the first light sources. Optionally the second light source may be a different light source from the first light source and/or the second light source may emit light in a different wavelength band from the first light source.

In the first embodiment, the portable device may include a second light guide for guiding illuminated light from the second light source to the second portion of the membrane and for guiding fluorescence light emitted by the excited fluorescent label to the second photodetector.

The microprocessor may be further operable to compare a ratio of the intensity of the fluoresced light from the first portion of the membrane to the measured intensity of the fluoresced light from the second portion of the membrane, against data stored in memory, to determine whether quality control parameters are within range.

In the first embodiment, the first light guide, or the first and second light guides, may be manufactured from a plastic material which is highly transmissive to the optimum excitation wavelength band for the fluorescent label.

The, or each, light guide may have a light receiving surface and a light exiting surface, where at least a portion of the light receiving surface is optically coupled to the respective light guide. In an embodiment, the, or each, light source may be set inside the respective light guide. Such an embodiment has the advantage of minimising Fresnel loss. Optical coupling of the, or each, light source to the respective light guide may be achieved with refractive index matching. Preferably the light receiving surface of the, or each, light guide is a smooth surface to ensure a high reflectance at a boundary formed between the light source and the light guide. Optionally, the, or each, light source may be coupled to a junction which is then optically coupled to the respective light guide. The junction may comprise an optically transmissive central section.

The, or each, photodetector may be optically coupled to the respective light guides.

The shape of the light exiting surface of the, or each, light guide is preferably configured to substantially conform to the shape of the respective portion of the membrane which emits fluoresced light. In an example, the first portion of the membrane is of a rectangular shape having an area of between 5 mm² and 15 mm², and more preferably between 6 mm² and 12 mm².

The, or each, light guide may be configured such that in use, the respective light exiting surface is proximate the respective portion of the membrane. For instance, in use the respective light exiting surface of each light guide may be positioned between 1 mm and 5 mm from the respective portion of the membrane.

The, or each, light guide may include a degree of curvature along at least a portion of their respective lengths.

The receiving member may include a base and a fastening member(s) to releasably fasten the membrane in position on the receiving member. The receiving member may include a pair of side walls and the fastening members may be in the form of a plurality of lugs inwardly projecting away from the side walls. The membrane may comprise a plurality of cut-outs and in use, the lugs of the receiving member may mate with respective cut-outs to retain the membrane in position.

Optionally, the fastening members may be in the form of grooves formed within the sidewalls and within which to receive longitudinal edges of the membrane. The receiving member may include a latch to engage an end of the membrane in a retained position and a latch release mechanism may be provided to release the membrane from the retained position.

In a second embodiment, the light guide may include a transmitting light guide and a receiving light guide. The transmitting light guide may be arranged to guide illuminated light from the first light source to the first portion of the membrane and a receiving light guide may be arranged to guide fluorescence light emitted by the excited fluorescent label to an input face of the first photodetector.

Each of the transmitting and receiving light guides may be manufactured from a plastic material which is highly transmissive to ultraviolet light. The transmitting light guide may include an optical filter. The optical filter may be an optical coating. The optical coating may be bonded, or laminated, to at least a portion of the transmitting light guide. Optionally, the transmitting light guide may be manufactured from a doped polymer so that the light guide transmits excitation wavelength in a band, matched for the target fluorophore. Similarly, the receiving light guide may include an optical filter. The optical filter may be an optical coating bonded, or laminated, to at least a portion of the receiving light guide. Optionally the receiving light guide may be manufactured from a doped polymer which transmits the emission wavelength in a band, for the flurophore.

The configuration of the transmitting and receiving light guides may be such that the fluorescence excitation of the lateral flow test is optimised, particularly for fluorophores exhibiting a relatively narrow Stokes shift.

The receiving member may be integrally formed as a portion of the housing. Optionally, the receiving member may be hinged to a portion of the housing. Optionally, the receiving member may be insertable within a body of the housing. A retaining member may be located within the housing to releasably retain the receiving member in position with respect to the housing. The retaining member is preferably one of an electromagnet and an electronically actuated latch means. The electronically actuated latch means may include a latch member to latch onto the membrane based assay under electronic control.

The device may further comprise an electronic actuator to enable multiple scans of the membrane based assay.

The receiving member may include a base and a fastening member(s) to releasably fasten the membrane in position on the receiving member. The receiving member may include a pair of side walls and the fastening members may be in the form of a plurality of lugs inwardly projecting away from the side walls. The membrane may comprise a plurality of cut-outs and in use, the lugs of the receiving member may mate with respective cut-outs to retain the membrane in position.

Optionally, the fastening members may be in the form of grooves formed within the sidewalls and within which to receive longitudinal edges of the membrane. The receiving member may include a latch to engage an end of the membrane in a retained position and a latch release mechanism may be provided to release the membrane from the retained position.

In an example of the second embodiment, the portable device may also be operable to scan a fluorescent-labelled, membrane based assay. In such an example the receiving member includes a transport mechanism to enable transportation of the receiving member relative to a light exiting surface of the transmitting light guide and a fluoresced light receiving surface of the receiving light guide. The receiving member preferably moves together with the membrane bases assay. The receiving member, together with the membrane based assay preferably moves at a rate, relative to the housing, of less than 10 mms⁻¹, and preferably at a rate of between about 1 mms⁻¹ and 5 mms⁻¹. The speed at which the membrane based assay moves may be variable.

The transport mechanism may include an elastomeric element which forms a portion of the receiving member, the elastomeric element being: biased to a resting condition, configured to compress when the receiving member is retained by the retaining member and configured, upon reduction of the compression force, to return to the resting condition. Preferably the elastomeric element is positioned at an end of the receiving member. The elastomeric element may be a compressible elastomer foam such as, but not limited to, polyurethane foam, or the elastomeric element may be constructed from a composite of foams, or a combination thereof. Optionally, the transport mechanism may include a spring and dampener arrangement.

The transport mechanism may further include a sensor to sense engagement of the receiving member with the retaining member. An output signal from the sensor indicative of the beginning of a test may be read into the microprocessor.

Optionally, the transport mechanism may include a toothed rack and the housing may further include a latch engager operable to engage with a tooth of the rack and a latch controller to control the latch engager to engage with subsequent teeth of the rack to thereby control movement of the receiving member. The latch controller may be an electronic controller.

The portable device may further comprise a controller to control the rate of transport of the receiving member. It should be appreciated that the controller is operable to retard or temporarily cease transport of the receiving member.

The controller may comprise:

an electromagnetic brake; and

a paramagnetic strip adhered to a portion of the receiving member; where the electromagnetic brake acts on the paramagnetic strip under control of the microprocessor to control the rate of transport of the receiving member.

In an example of the second embodiment, the first photodetector further detects fluoresced light emitted by an excited fluorescent label captured by a control reagent laid down in a second portion of the membrane and to measure an intensity of the fluoresced light, where the second portion of the membrane is downstream from the first portion of the membrane. The microprocessor may be further operable to compare a ratio of the intensity of the fluoresced light from the first portion of the membrane to the measured intensity of the fluoresced light from the second portion of the membrane, against data stored in memory, to determine whether quality control parameters are within range, and also as a means of compensating for differences in membrane flow rate.

The microprocessor is further operable to normalise the intensity of the fluoresced light from the first portion of the membrane and from the second portion of the membrane, to compensate for variations in the rate of transport.

As per the discussion in relation to the first embodiment, the light source may be a pulsed light source and the first photodetector may be a time gated photodetector.

The microprocessor may include, or operate in conjunction with, timing circuitry in communication with the first light source and the time-gated detector, to control pulsed excitation and detection. The microprocessor and timing circuitry may be operable to:

(i) direct the first light source to turn on;

(ii) direct the first light source to turn off after a first time period; and

(iii) measure the intensity of the fluoresced light after a second time period measured from when the light source is directed to turn off.

The microprocessor and timing circuitry may be further operable to repeat (i) to (iii) for a certain number of times and to average the results. This procedure is referred to hereon as time-gated fluorescence.

The portable device may further include signal processing means connected to the photodetector and the microprocessor. The signal processing means may comprise a variable gain amplifier connected to an output of the photodetector; and a feedback circuit connected to the a variable gain amplifier for controlling the gains thereof. The signal processing means may further comprise an analog-to-digital converter.

The microprocessor may be further operable to produce a gain control signal for reducing the gain of the variable gain amplifier if a saturation condition exists. The microprocessor may be further operable to determine a theoretical intensity of the fluoresced light to determine whether the analyte is present and/or to determine the quantity of analyte present in the sample. The theoretical intensity of the fluoresced light may be determined by multiplying the signal level at the reduced gain by the reduced gain value.

The housing may include a display for displaying diagnostic results from an assay. Diagnostic results may be a qualitative test result and/or a quantitative test result.

The housing may further include a user interface. The user interface may be navigatable by way of one or more push buttons. Optionally, the user interface may be navigatable by way of a touch screen interface.

The portable device in accordance with an embodiment of the invention is additionally operable to read a fluorescent-labelled calibration membrane based assay (a calibration test strip). In such an embodiment, the microprocessor is further operable to compare the intensity of the fluoresced light received from successive portions of the membrane against data stored in memory, to determine whether quality control parameters have met pre-determined specifications. The microprocessor may report a status of the portable device to a user via a display. Optionally, or in addition the microprocessor may report a status of the portable device to a remote server.

Whilst the broad aspect of the invention and its embodiments above have been described with particular reference to fluorescent-labelled lateral flow assays, it is also applicable to lateral flow assays labelled by other means, such as, upconverting phosphors.

### BRIEF DESCRIPTION OF THE DRAWINGS

Preferred embodiments of the present invention will now be described, by way of example only, and with reference to the accompanying drawings in which;—

FIG. 1 is a view of a fluorescent-labelled, membrane based assay (LF strip);

FIG. 2 is a view of a portable device for reading a fluorescent-labelled LF strip in accordance with a first embodiment of the invention;

FIG. 3 is a view of the relative positioning of the transmitting and receiving light guides illustrated in FIG. 2 relative to the LF strip;

FIG. 4 is a view of a portion of the portable device illustrated in FIG. 2;

FIG. 5 is a view of an exterior of the housing of the portable device;

FIG. 6 is a view of the LF strip carrier as illustrated in FIG. 2;

FIG. 7 shows an alternative LF strip carrier;

FIG. 8 is a view of the electronic components of the portable device shown in FIG. 2;

FIG. 9a shows a test and control strip signal received by the signal processing means, without any application of the adjustable gain;

FIG. 9b shows a control strip signal received by the signal processing means, with application of the adjustable gain;

FIG. 10 is a view of a portable device for reading a fluorescent-labelled, membrane based assay in accordance with a second embodiment of the invention;

FIG. 11 is a view of the capture of fluorescent emitted light from the second embodiment of the invention;

FIG. 12 shows a timing diagram for square wave pulsing of an LED accompanied by a phase-delayed signal for detection by a photodetector together with the typical fluorescent emissions response curve for a lanthanide chelate label;

FIG. 13 shows a colour image from a high resolution camera of five of the test strips at four different concentrations, for conventional visual, blue-dyed latex beads;

FIG. 14 shows a graph illustrating the results of the Fluidyx opto-electronic module (FOM), which is part of the subject matter of this invention, scanning a Europium test line at 0.00078% bead concentration;

FIG. 15 shows a graph comparing the detectability of the Europium test lines using the FOM to a conventional laboratory spectrophotometer; and

FIG. 16 shows a graph of the linearity of the response of the FOM, in terms of fluorescent response versus bead concentration.

### DETAILED DESCRIPTION OF PREFERRED EMBODIMENTS

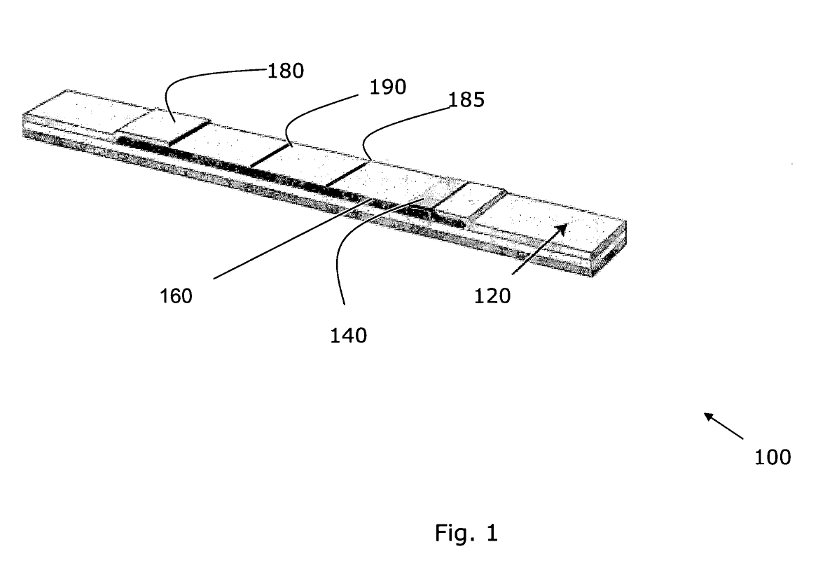

Referring to the drawings, FIG. 1 illustrates a fluorescent-labelled, membrane based assay, referred hereinafter as a lateral flow (LF) strip, 100 as commonly used in rapid diagnostic applications. The LF strip 100 contains a sample application pad 120, a conjugate pad 140, a membrane 160 composed of nitrocellulose along which a sample containing an analyte flows, and a waste adsorbing pad 180.

The membrane designates two zones. A first portion of the membrane is referred to as the test zone, or test line 185. A second portion of the membrane is referred to as the control zone, or control line 190. Immobilised on the membrane, the test line 185 contains capture antigens or antibodies for the target(s) of interest. Whilst only one test line is shown, several test lines may be present containing the same, or different antigens or antibodies for different targets of interest. Immobilised on the membrane, the control line 190 contains a control capture antigen or antibody. The LF strip 100 is approximately 5 mm wide and the area of each of the test line 185 and control line 190 is approximately 6 mm².

Using any known means, a fluorophore label is conjugated to the target and control secondary antibody, or antigen, in the sample as the sample wicks through the sample application pad 120 and an adjacent conjugate pad 140 prior to passing through the membrane 160. In each of the described embodiments, the fluorophore is europium chelate, which is known to have a large Stokes shift in terms of the wavelength of light required for excitation (ultraviolet light of wavelength 340-360 nm), and the light emitted by the fluorophore (615 nm). Two characteristics of the chelated lanthanides generally, that ensure an outstanding analytical sensitivity, are a large Stoke's shift (i.e. the wavelength shift between the excitation and emission light is larger than 200 nm) and a long fluorescent decay time.

The LF strip 100 deployed in FIG. 1 may also be contained in a plastic cassette (not shown) containing an opening for sample introduction and an open “window” for viewing the test and control lines.

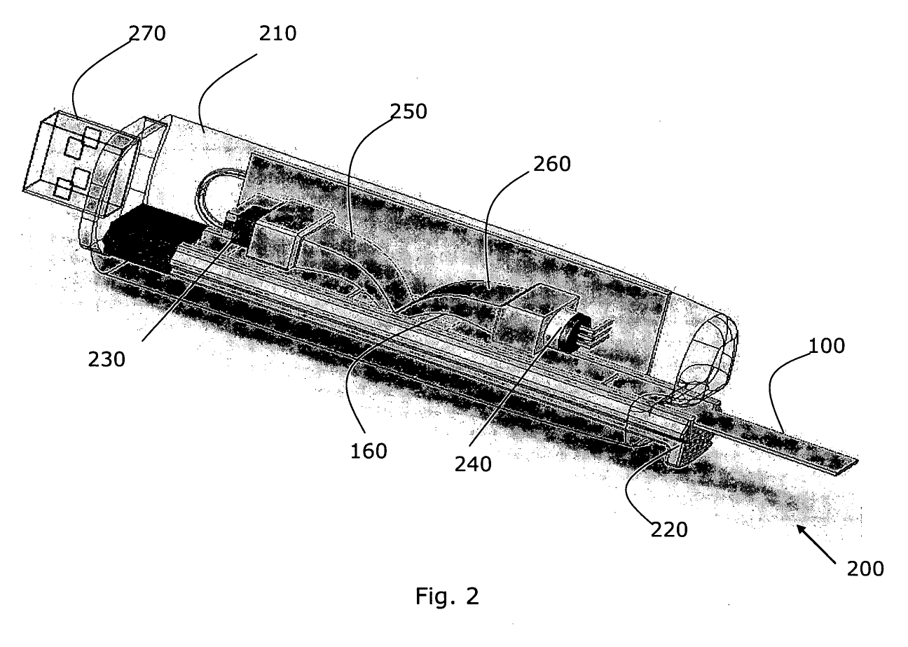

FIG. 2 illustrates a portable device 200 for reading an LF strip 100, in accordance with a first embodiment of the invention. In this embodiment, the portable device 200 is further operable to scan the LF strip 100.

The portable device 200 comprises a light sealed housing 210 which includes a receiving member 220 to receive a LF strip 100. The light sealed housing 210 houses first light source 230 in the form of light emitting diode (LED) for illuminating the test line (not shown) on the membrane 160 with light. The LED 230 emits light in the ultraviolet range 340-360 nm, which is the optimum excitation wavelength band for the lanthanide chelates. The light sealed housing 210 further houses a photodetector 240 for detecting fluoresced light emitted by an excited fluorescent label captured by a reagent laid down in the test line and to measure an intensity of the fluoresced light. The photodetector 240 is selected to have a peak sensitivity in a range which is the optimum band for detection of the nominated fluorophore. The light sealed housing 210 further houses a transmitting light guide 250 arranged to guide illuminated light from the LED 230 to the test line and a separate receiving light guide 260 arranged to guide fluoresced light emitted by the excited fluorescent label to an input face of the photodetector 240.

The transmitting light guide 250 is manufactured from a doped plastic material which only transmits the excitation light wavelength for the fluorophore in a narrow band, or alternatively up to a “cut-off” value. The receiving light guide 260 is manufactured from a doped plastic material which only transmits the emission light wavelength for the fluorophore in a narrow band, or alternatively above a “cut-off” value.

The geometry of the transmitting light guide 250 and receiving light guide 260 is such that a bend angle is incorporated into the respective light guides 250, 260. This geometric layout suits a very compact portable device 200. Total internal reflectance within the transmitting light guide 250 and receiving light guide 260 ensures that the maximum amount of light from the LED 230 is delivered to the test and control lines in order to maximise excitation, and that the maximum amount of fluoresced light is received at the photodetector 240.

The transmitting light guide 250 has a light receiving surface and a light exiting surface. The receiving light guide 260 has a fluoresced light receiving surface and a fluoresced light exiting surface. The light exiting surface and the fluoresced light receiving surface are each shaped to substantially conform to the shape of the test line, which as previously described has an area of approximately 6 mm². In effect, the light exiting surface and the fluoresced light receiving surface are each rectangular shaped, having an area of about 8 mm², to ensure that the light illuminate onto the test and control lines is concentrated into a rectangular slit shape in order to maximise the intensity of the light exciting by the fluorescent label captured by the reagents laid down in the test and control lines, and to maximise the fluorescent emissions received by the photodetector 240.

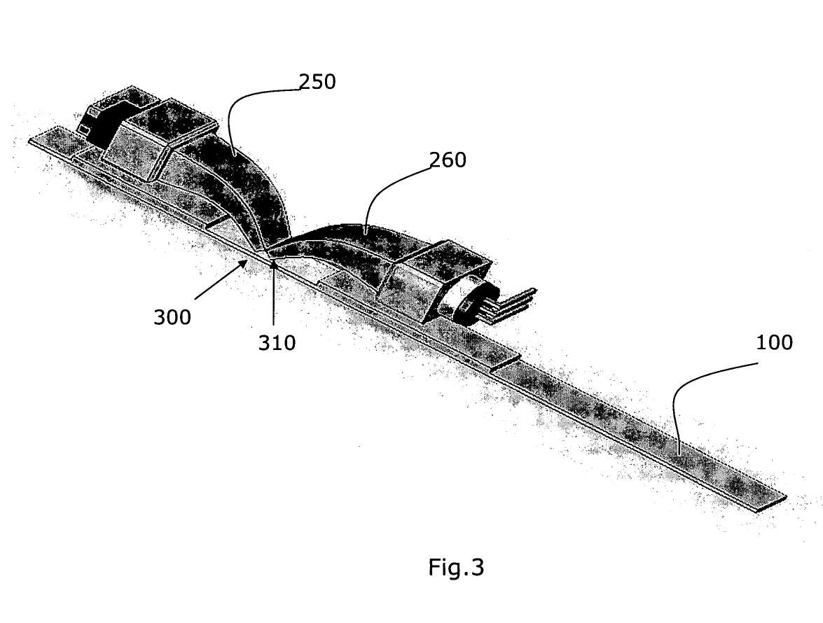

FIG. 3 illustrates the relative positioning of the light exiting surface 300 and the fluoresced light receiving surface 310 relative to the LF strip 100. The light exiting surface 300 of the transmitting light guide 250, and the fluoresced light receiving surface 310 of the receiving light guide 260 are positioned as close as possible to the surface of the membrane and therefore as close as possible to each of the test and control lines when the LF strip 100 is scanned beneath the fluoresced light receiving surface. In this manner, it has been found that higher intensity light can be delivered to the test and control lines, and that a higher proportion of the fluorescent light can be detected at the photodetector 240 for signal processing. It has also found to be advantageous that the transmitting light guide 250 and receiving light guide 260 are each optically coupled to either the LED 230 or the photodetector 240 with a high optical transmission optical coupling compound, which may be cast (in liquid state) between the light guide and the mating optical component and which subsequently sets into a rigid state.

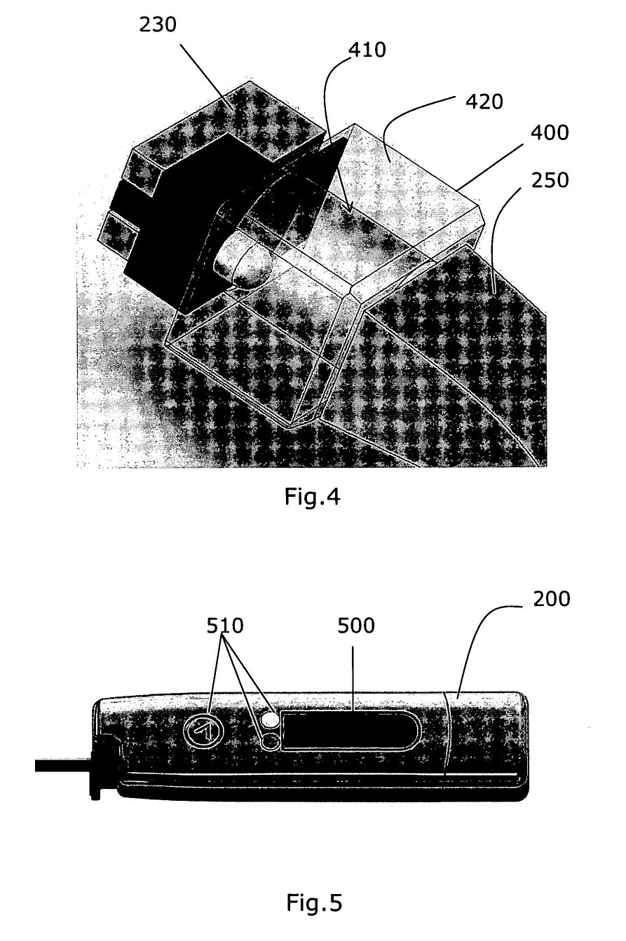

Detail of the coupling between the LED 230 and the transmitting light guide 250 is illustrated in FIG. 4. Fitted to the LED 230 is a separate housing 400 which has a single light inlet and single light exit portion where light exits the LED 230 through an optically transmissive central section 410 before entering the light receiving surface of the transmitting light guide 250. The remaining portion 420 of housing 400 outside the central section 410 is opaque. This arrangement has been found to be advantageous in terms of reducing the amount of unwanted stray light which would otherwise register a faint signal level at the photodetector 240. It should be appreciated that other methods of housing the LED 230 in a separate light-tight housing component may also be employed.

Referring back to FIG. 2, the portable device 200 is highly compact having dimensions less than 30 mm width, 20 mm height and 100 mm length. The portable device 200 includes a USB interface 270 to enable the device 200 to communicate with a wide range of external computing devices (not shown), including PCs, PDAs, mobile telephones, and other like digital devices. External computing devices may in turn be used to connect to other optional peripherals, including printers, bar code scanners for sample tracking, fingerprint recognition systems, cameras, and other devices. External computing devices may also be used for uploading the results of assays stored on device 200 to external medical records databases. It is also preferred that the USB connector 270 is used as a means of re-charging batteries (not shown) deployed as the power source inside housing of the device portable 200. The connection of the portable device 200 via the USB interface 270 to an external computing device also enables the firmware embedded in the device's microprocessor (not shown) to be updated as new changes to assay protocols are determined, or to add new assay protocols to the system.

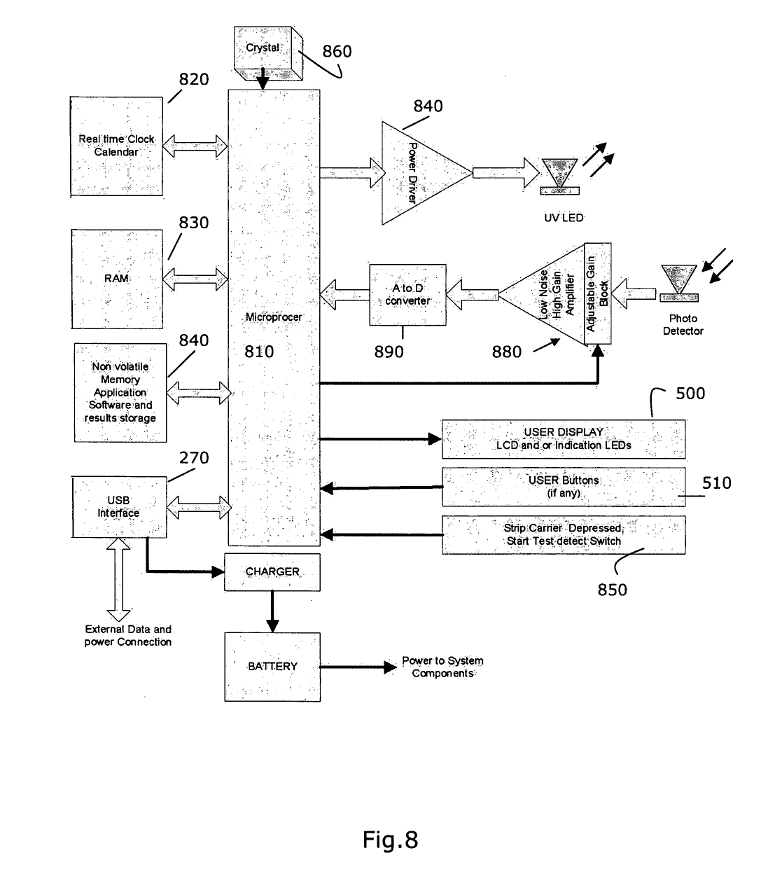

The USB interface 270 offers numerous advantages over conventional LF tests (whether used with or without a bench top reflectance photometer). The first of these advantages relates to the compactness of the device 200, the result of only requiring incorporation of a very small “button” sized battery which is re-charged on connection to the computing device. Other devices requiring mains power or self-contained replaceable or re-chargeable batteries require much large power supplies. The second advantage relates to the efficient storage of data and which is described in detail with reference to FIG. 8. A third advantage relates to the possible use of the device when connected to a portable computing device with GPS capabilities for epidemiological studies. The work of communicable and non-communicable disease epidemiologists ranges from outbreak investigation, to study design, data collection and analysis including the development of statistical models to test hypotheses. The portable device 200 in connection with a GPS-enabled external computing peripheral allows for direct and immediate upload of data on the severity and location of particular diseases, which is of importance to epidemiologists in being able to understand, monitor, and control outbreaks of infectious diseases.

FIG. 5 illustrates an exterior of the housing 210 of the portable device 200. A display 500 is provided together with a user interface navigation controller 510, comprised of a set of pushbuttons. Since the portable device is reusable, the navigation controller 510 enables a user of the portable device 200 to view the results of any particular assay, and to navigate through any previous assay results. The results of any particular assay measured by the portable device 200 are able to be shown on the display 500 either as a qualitative result (in terms of the test being positive or negative), or as a quantitative or semi-quantitative result (in terms of displaying the amount of the target analyte present).

In the case of qualitative results, the portable device 200 reports such test results in a manner compatible with CLIA waiver guidelines. In the case of quantitative or semi-quantitative result, the microprocessor within the device shall compare the ratio of the fluorescent intensity of the test and control lines to a look-up table programmed into the microprocessor firmware in order to correlate a particular fluorescence intensity ratio to known levels of analyte concentration. In either of the cases where the portable device 200 is used for qualitative, quantitative, or semi-quantitative measurement appropriate quality control steps shall be built into the instrument to reduce and minimise the possibility of test errors in accordance with CLIA waiver guidelines.

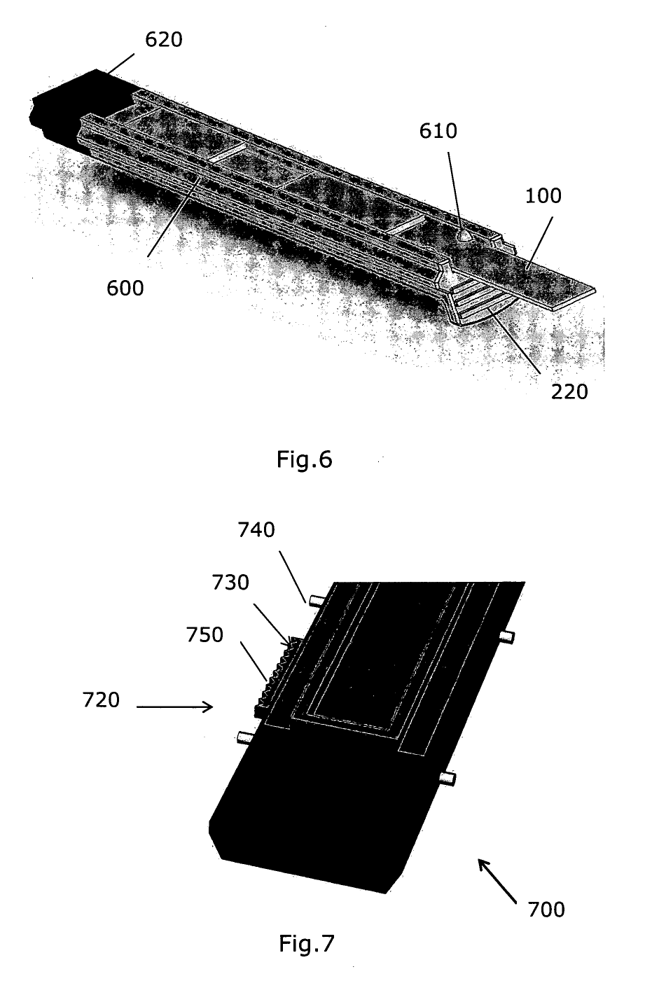

The LF strip 100 is loaded into the portable device 200 via a receiving member 220 shown in FIG. 2 and shown in more detail in FIG. 6. The receiving member 220 (referred hereinafter as the strip carrier) includes a base 600 and one or more retaining members in the form of lugs 610 to releasably retain the LF strip 100 in position on the strip carrier 220.

When the LF strip 100 slides along the base 600 of the strip carrier 220 the lugs 610 mate with matching cut-outs (not shown) in the LF test. This ensures that the LF strip 100 is located in a fixed and known position relative to the strip carrier 220 and therefore the light exiting surface and the fluoresced light receiving surface of the respective light guides when the strip carrier 220 is inserted into the housing 210 of the portable device 200.

To enable scanning, the strip carrier includes a transport mechanism 620 to effect transportation of the LF strip 100 past the light exiting surface of the transmitting light guide and past the fluoresced light receiving surface of the receiving light guide. The transport mechanism 620 includes an elastomeric element in the form of a resilient foam element positioned at an end of the strip carrier 220.

When the strip carrier 220 is inserted into the device 200, a retaining member in the form of an mechanical detent (not shown) in the device 200 releasably locks the strip carrier 220 into position relative to the housing 210 to prevent the strip carrier 220 falling out in normal use. To initiate a test a user depresses the strip carrier 220 fully into the housing 210 of the device 200. This causes compression of the resilient foam element 620. The depression is detected by a travel operated switch or sensor (not shown) within the portable device 200. The switch, or sensor, generates a signal which can be used to initiate a test, and provide feedback to the user of the test in progress and status. The feedback is provided either by a visual display and/or an audible beeper. When the detent is released, the compressed foam element 620 progressively moves the strip carrier 220 in such a manner that the test and control lines are respectively moved past the light exiting surface of the transmitting light guide and past the fluoresced light receiving surface of the receiving light guide. The compressed foam element 620 may be a “closed cell” foam chosen such that it provides spring return to the spring carrier at a slow progressive velocity, and it is not necessary to the correct operation of the test that the return velocity is uniform or repeatable from one test to another.

The retaining member may optionally, or in addition, be in the form of an electronically actuated latch element, or small electromagnet. When the strip carrier 220 is fully depressed into the housing 210 of the portable device 200, a small electromagnet, (not shown) in the housing 210 of the device 200 releasably locks the strip carrier 220 in the fully inserted position. This has the advantage that the carrier can be cleanly released, at a time or delay that suits the portable device 200 and the test protocol to be applied.

A typical example is where the portable device 200 prompts the user via the display 500 to provide multiple depressions, to allow functions such as averaging, or monitoring the amplitude development of the test and control lines over time, at each consecutive transport. In this case, the user can simply depress the strip carrier 220 each time the portable device 200 is fully returned to its resting position. This can be indicated by an audible and visual indication to the user. The latching function enables the microprocessor (see FIG. 8) to accurately control the time delay between each release, to achieve a specific test protocol and set of time spaced measurements.

FIG. 7 shows a portion of the strip carrier 700 having an alternative transport mechanism 720 to effect transportation of the LF strip past the light exiting surface of the transmitting light guide and past the fluoresced light receiving surface of the receiving light guide. The transport mechanism 720 includes an integrally-moulded rack 730 added to an end of the strip carrier 700. The rack 730 includes a multiplicity of teeth 750. The rack 730 is intended to interact with the electronically controlled latch (not shown) in the portable device 200 in such a manner that the electronically controlled latch is able to be progressively pulsed, to release the strip carrier 700 from the device at a release rate equivalent to the pitch of one of the teeth 750 in the rack 730 per actuation of the latch. This ensures that the strip carrier 700 can be released at a controlled and progressive rate, with precise position control. If required, the portable device 200 (by way of firmware instruction from its microprocessor) can thereby stop the release of the LF strip temporarily at the known positions where either the test strip or control strip are aligned with the light exiting surface of the transmitting light guide, and the fluoresced light receiving surface of the receiving light guide. In this way, the portable device 200 can stop the strip carrier 700 and analyse possible changes in intensity of the signal of either the test or control strips for extended periods. The main reason for this is that the rate of change (of signal intensity versus time) has importance in some diagnostic applications where the binding of the primary antibody-antigen-secondary antibody “sandwich” at the test and control stripes changes over time.

The function of control and progressive release of the strip carrier 220 can also be achieved, where the strip carrier 220 incorporates a paramagnetic strip (not shown) such as a steel strip that can be acted on by a small electromagnetic brake (not shown). The microprocessor (labelled 810 in FIG. 8) then uses micro-releases of this brake to incrementally release the strip carrier 220 out to its resting position, over an extended and controlled time period.

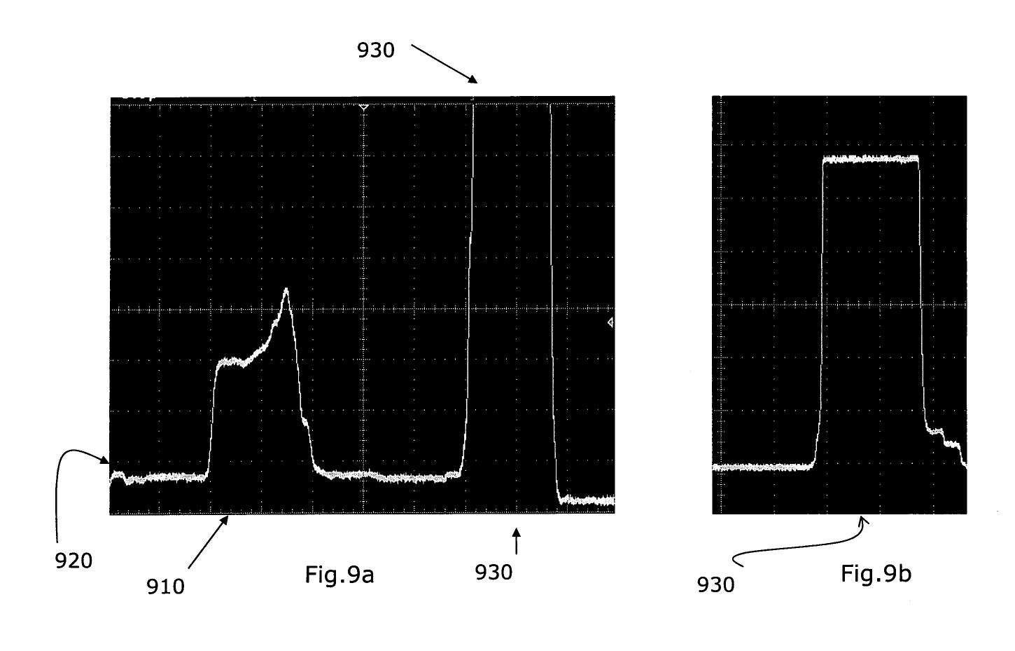

The portable device 200 could further contain an optional second long-stroke micro electronic actuator (not shown) to pull the strip carrier 220 back into the housing 210 of the portable device 200 for multiple automated, detection passes. This feature could be important for assay applications where it is desired to monitor the level of change in the test and control strip intensity at several time intervals.

Where the transport system uses a very low cost actuator such as a simple spring/damper or compressible foam block, the transport speed of the system, can vary in particular between subsequent depressions of the carrier, or over time or over temperature. The resulting waveforms (such as those shown in FIG. 9a) representative of the continuous measurement of the return signal as the LF strip 100 progresses past the light exiting surface of the transmitting light guide, carry important test verification information. Effectively the known test line width and control line width and distance between the test and control lines (or successive lines) can be used to measure the transport speed, and to normalise the result, to remove transport speed from the calculated test result.

This measurement of transport speed can also be used ensure that the speed is within a known acceptable range for a valid test. If for example the transport speed is out of range, then the user can be prompted to repeat the test, and depress the strip carrier 220 again. If transport speed errors continue to occur, the user can be prompted by the microprocessor and internal software, to have the device serviced. Typically this would be replacement of the test carrier and its integrated compressible foam block, in the event that the block is damaged, or has suffered wear.

In addition the waveform information can be used to provide quality control information to validate the test and the control strip 220. This method can eliminate faulty or incorrectly manufactured control strips, determined by out of specification line widths, incorrect spacing between test and control lines, excessive background noise, (baseline) level, etc.

Data from the waveform is able to be used to calculate the test result. Characteristics such as the area under each test curve, the shape of the curve, the amplitude of each curve and ratio of these properties between test lines and the control line, can all be incorporated into software routines within the portable device and used to determine a test result.

The strip carrier 700 shown also contain lugs 740 which mate with an “S” shaped sliding tracks (not shown) in the housing 210 of the portable device 200. When the strip carrier 700 is inserted into the device, the strip carrier lugs 740 move in mating sliding tracks of the housing 210 of the portable device 200 in such a manner that the strip carrier 700 ramps the test window in the LF strip (which contains the test and control strips) up to the light exiting surface of the transmitting light guide and the fluoresced light receiving surface of the receiving light guide. This operation ensures that the test and control strips can be positioned as closely as possible to the light exiting surface and fluoresced light receiving surface, thereby maximising optical efficiency.

FIG. 8 shows a schematic diagram of the electronic components of the portable device 200 for power management, signal processing, data storage, and results display and data communications management. The electronic components and associated connectors are mounted on a printed circuit board (not shown).

A low cost microprocessor 810 is provided for control of the instrument and for signal processing and analysis. The microprocessor 810 is in data communication with a real time clock and calendar 820, RAM 830, a non volatile memory and associated software 840, the USB interface 270, the user display 500, navigation controller 510, a strip carrier release mechanism and start test button 850, crystal oscillator 860, a power driver, and signal processing means in the form of a low noise high gain amplifier with adjustable gain 880, and an Analogue to Digital Converter (ADC 890).

The non volatile memory 840 is available to store the results of all tests for the life of the device. Each of the test results so-stored may be identified by time and date stamping, and this information may be stored as “metadata” with the test result, thereby uniquely labelling each test result. In connection with software from a host computer a “folder” based data storage method (determined by the user) can be customised, thereby allowing ease of test data filing and retrieval. Furthermore, if the LF strip is enabled with identifications means, for example a Radio Frequency ID tag, a magnetic stripe, a barcode, or an anti-counterfeit identity the portable device 200 may further be provided with means to read the LF strip ID information means. The LF strip ID information may include the type of assay, thereby automatically enabling the portable device 200 to determine which test protocol to run. The LF strip ID information may also include the test batch number and date of manufacture, and this information may be included with the metadata included with the test result and stored in the memory of the portable device 200. Moreover the housing may contain a unique silicon serial number as an anti-theft measure. The device may be required to be intermittently revalidated against data contained in a central server to aid against theft.

FIG. 9a shows a typical test and control strip signal received by the signal processing means (without any application of the adjustable gain) of the portable device 200 under conditions where the analyte concentration is low, and the test line signal 910 is therefore low. The signal shows the detection of a low level of a sample which contained chlamydia trachomatis (CT) at a concentration of 1×10⁴ Elementary Bodies of CT/ml using a known fluorophore. In this example the device is able to detect analyte concentrations at a level of more than 100× below than that which is possible with a conventional LF strip.

With reference to the transport mechanism and FIG. 9a, as the foam, or spring damper arrangement recovers and transports the area of the test strip and control strip under the fluoresced light receiving surface of the receiving light guide, an electronic signal is generated that is recorded, processed and stored to memory 840. The signal illustrated in FIG. 9a is a typical return signal. Data indicative of the signal strength of the background noise 920, test strip 910 and control strip 930 are all available as digital values to internal software to be calculated as a test result, and can be, displayed on the display 500, and/or transmitted via the USB interface 270 or be retained in memory 830 for future transmission to remote computers/web servers when the portable device is subsequently connected to a data port.

The signal processing means 875 is provided with a custom-designed amplifier to detect faint signal levels from fluorophores under conditions of weak analyte concentration. As illustrated, it is possible to detect a signal 910 from the test strip of several hundred millivolts, and the microprocessor 810 is able to clearly differentiate this signal as being many times higher than background membrane noise levels 920, which may contain non-specific membrane binding effects. Non-specific membrane binding effects constitute unwanted “noise”, and unless the test signal levels are significantly above this unwanted “noise”, then it is not possible to interpret a positive test result at low analyte concentrations. Although the test strip signal 910 is detectable, the signal level of the control strip 930 with very high gain amplification saturates the photo-detector 240. This means that the dynamic range of the portable device 200 would be compromised by only being able to detect low analyte concentrations, and that quantification of analyte concentrations under conditions of high analyte concentrations, or quantification of the control strip signal intensity would not be possible. To address this problem the signal processing means utilises a low-cost amplifier having an iterative digital gain.

Under conditions where either the test strip signal or the control strip signal saturates the photodetector 240, a saturation signal is produced which is indicative that the amplified signal output from the variable gain amplifier 880 has exceeded a predetermined value (photodetector saturation limit).

The microprocessor 810 then iteratively reduces the amplifier gain 880 until a signal level is reached which is just below the photodetector saturation limit. The microprocessor 810 then stores the actual gain value to which the amplifier 880 was iteratively reduced, and uses this reduced gain value multiplied by the signal level at the reduced gain, to interpolate a theoretical test strip or control strip signal intensity value. This interpolated value may be considerably above the photodetector saturation limits. In this way, the dynamic range of the portable device 200 is extended to be a hybrid of a high-gain system for conditions of low analyte concentration on the test stripe, as well acting as a lower-gain system for detection of high analyte concentrations, and for detection of the higher intensity control strip signal.

FIG. 9b shows the iterative digital gain applied to the control strip signal of FIG. 9a, such that an interpolated control strip intensity value can be computed which may be greater than the saturation limit of the photodetector 240.

As has been described previously, the transit speed of the LF strip relative to the housing may not be uniform. The microprocessor is operable to extract data indicative of the width of the test and control lines. This data may be normalised and compared against known data stored in memory to determine whether quality control specifications are met. If the comparison is outside of quality control standards the test will be rejected as it may indicate a fault of the transport mechanism or a fault in the labelling of the test strip itself.

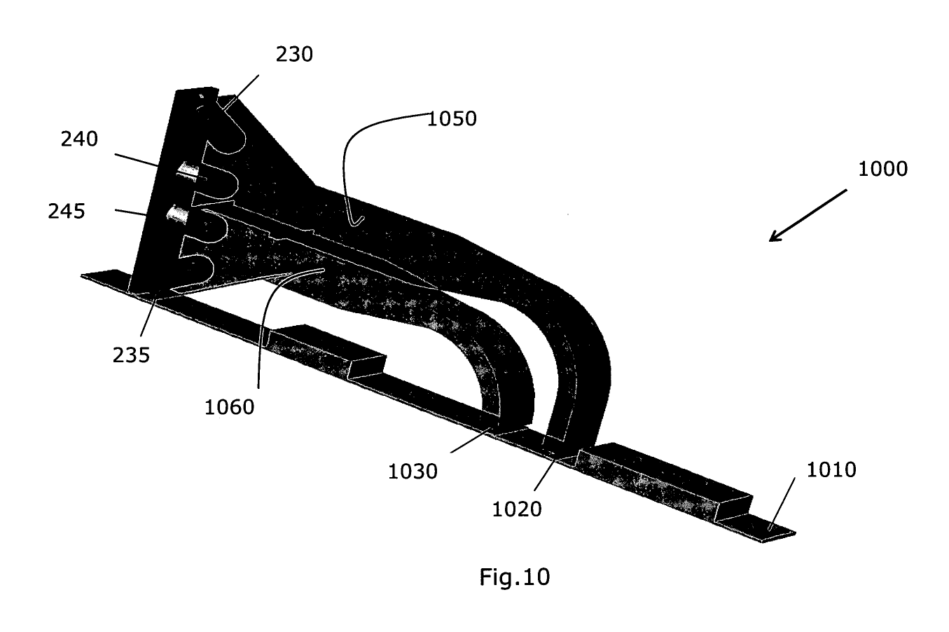

FIG. 10 illustrates a portable device 1000 for reading a fluorescent-labelled, membrane based assay 100 in accordance with a second embodiment of the invention. The fluorescent-labelled, membrane based assay, referred hereinafter as a lateral flow (LF) strip, is the same as that illustrated in FIG. 1. In the subsequent drawings, like numerals refer to the same or similar functionality throughout this second embodiment.

The portable device 1000 comprises a light sealed housing (not shown) which includes a receiving member (not shown) to receive a LF strip 100. The light sealed housing houses a first and a second light source 230, 235 for illuminating the test line 1020 and the control line 1030 respectively with light. The first and second light sources 230, 235 are LEDs which emit light in the range 340-390 nm UV range, with the optimum value being 350 or 360 nm commercially available LEDs, which is the optimum excitation wavelength band for the nominated fluorophore. The light sealed housing further houses a first photodetector 240 for detecting fluoresced light emitted by an excited fluorescent label captured by a reagent laid down in the test strip 1020, and for measuring an intensity of the fluoresced light, and a second photodetector 245 for detecting fluoresced light emitted by an excited fluorescent label captured by a reagent laid down in the control strip 1030, and for measuring an intensity of the fluoresced light. The photodetectors 240, 245 ideally have a peak sensitivity in a range which is the optimum band for detection of the nominated lanthanide chelate detection system.

A first light guide 1050 guides illuminated light from the first LED to the test strip 1020 and for guiding fluoresced light emitted by the excited fluorescent label to the first photodetector 240 whilst a second light guide 1060 guides illuminated light from the second LED to the control strip 1030 and for guiding fluoresced light emitted by the excited fluorescent label to the second photodetector 245. The first and second light guides 1050, 1060, are manufactured from a plastic (acrylic) material which is highly transmissive to UV light. Total internal reflectance within the respective light guides ensure that the maximum amount of light from the LEDs 230, 235 is delivered to the test strip 1020 and the control strip 1030 in order to maximise excitation, and that the maximum amount of fluoresced light is received back to the respective photodetectors 240, 245. As for the first embodiment the light exit portion of the first and second light guides 1050, 1060 has a rectangular slit shaped geometry to ensure that the light pattern of the test and control strips is concentrated into a rectangular slit shape, again in order to maximise the intensity of the light exciting the test strip and control strip. As is also illustrated, the light exit portion of the first and second light guides 1050, 1060 is, in use, positioned as close as possible to the test and control strips (of the order of one to two millimetres). In this manner, it has been found that higher intensity light can be delivered to the test strip 1020 and control strips 1030, and that a higher proportion of the fluoresced light can be returned to the respective photodetectors for signal processing.

This is in contrast to the capture of reflected light in a conventional reflectance photometer. In a conventional reflectance photometer a light source is typically placed remotely from the target, at an incident angle to the target, and often directly above the target. The problem with this type of arrangement in the case of the LF strip is that the membrane surface (known as a Lambertian surface) is diffuse. Subsequently, light rays from the source are reflected over a wide range of angles and the photometer's photodetector typically only captures a relatively small portion of all of the reflected light rays. The net effect is that the sensitivity of the reflectance photometer is considerably less than the device constructed in accordance with the embodiments of the invention.

Referring back to FIG. 10, because the first LED 230 and the first photodetector 240 share the first light guide 1050 and since the second LED 235 and the second photodetector 245 share the second light guide 1060, the light exit portion of the first and second light guides 1050, 1060 respectively can be configured within the housing, to be positioned directly above the test line and control line respectively. Further, since the first and second light guides 1050, 1060 are manufactured from optically clear acrylic material, which is totally-internally reflective, light may be injected into each of the light guides from the respective ultraviolet LEDs, and each of the light guides act to collimate and intensify the light passing through the respective light guide to the rectangular light exit portion. The geometry of the light exit portion is chosen to be slightly larger than the area of the test strip and control strip, in order to ensure that minimum light is wasted in illuminating other portions of the membrane which have no bearing on the assay.

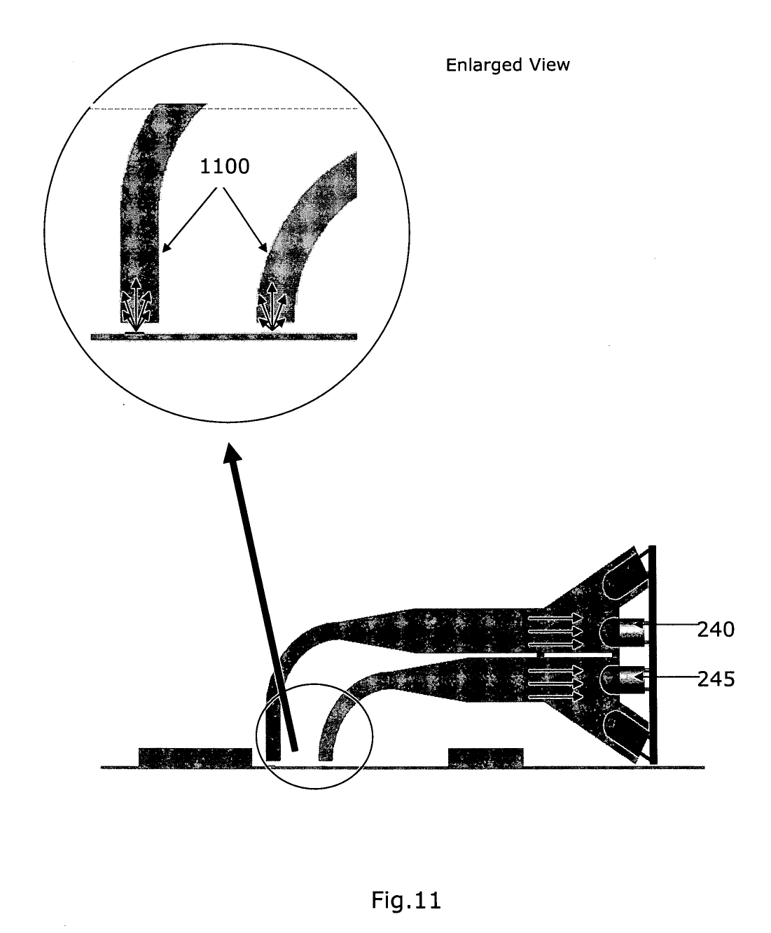

FIG. 11 shows that reflected light rays 1110 over a wide range of angles spanning an included angle of just under 90° are captured by the light guide, and passed in a relatively collimated manner back to each of the photodetectors 240, 245. In this manner, a much greater portion of the fluorescent emissions from the test strip and control strip is passed back to the respective photodetectors 240, 245 for signal processing, thereby ensuring higher sensitivity of the system.

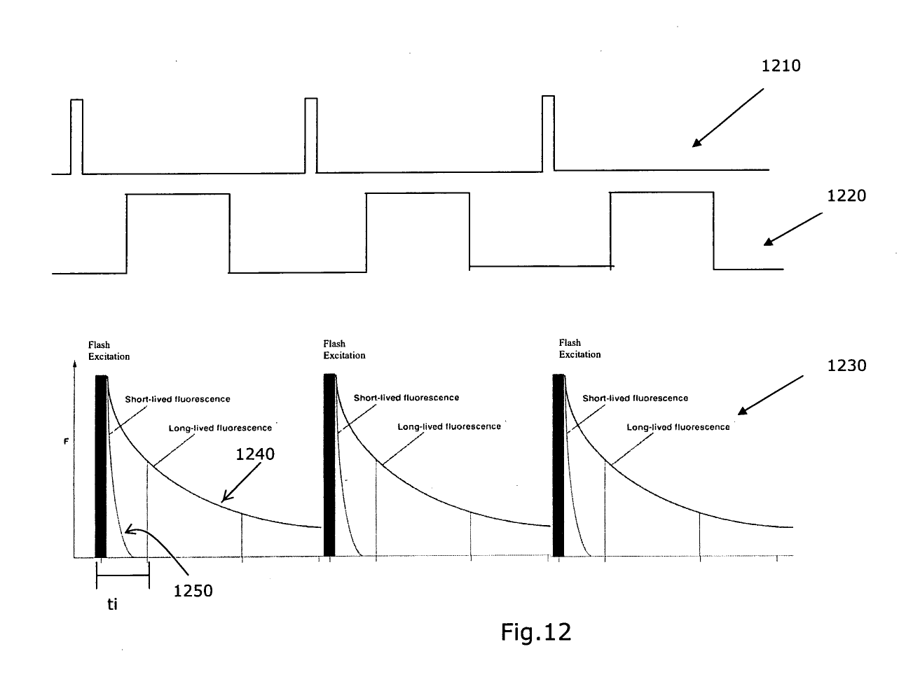

FIG. 12 shows a timing diagram used in time-gated fluorescence. The signal 1210 is used to pulse the ultraviolet LEDs and also triggers the phase-delayed timing of the detected signal 1220 from the photodetectors. During the period when the light source is switched on, the fluorophore target line is emitting a long-lifetime fluorescent signal, together with other elements (such as the membrane per se) which are also emitting (unwanted) short-lifetime fluorescent signals. During this period, the detector is switched off (which is the opposite of a conventional reflectance or absorbance fluorometer or spectrophotometer). The light source is then switched off and, (after a delay period of >100 microseconds), the photodetector is switched on. Then the photodetector cannot detect any light from the excitation source (which is in the off state), and nor can it register any light from unwanted background fluorescence, which have decayed to zero as a result of being short-lived. The only emitted light remaining to be detected is the long-lived fluorescence from the lanthanide chelate label, which is the desired fluorescence emission from the target.

In this manner, the signal 1220 detected by the photodetectors is analysed by the instrument at a time when there is no incident light from the ultraviolet LEDs, and when the short-lived fluorescent effects of unwanted fluorescent background emissions have decayed to zero. By eliminating unwanted light from the ultraviolet LEDs and by eliminating unwanted background fluorescence, the photodetectors receive only light emitted by the excited fluorophore label. In this way the alternate and repeated square wave pulsing of the light source and the photodetector is used to filter out unwanted light at the photodetector. This alternate square wave pulsing can be achieved using a very low cost, robust, and compact microprocessor, which is much cheaper and more robust than the use of complex optical filter sets described in conventional systems.

The graph 1230, repeated to correspond to the timing diagram of the signal 1210 shows the typical fluorescent emissions response curve for a lanthanide chelate label. Curve 1240, shows that the lanthanide chelate ion has a long fluorescent decay period, compared to other fluorescent effects from unwanted background signals which have short fluorescent decay periods 1250. Any fluorescent signal which is measured more than t₁ seconds after the excitation source is switched off will only be the signal of the by the excited fluorophore label, and not that of the short-lived fluorescence effects.

The combination of the pulsing of the LEDs and the phase-delayed timing of the detected signal ensures that the signal to noise ratio is maximised, which ensures optimum sensitivity for the device. It has also been found that the LEDs are able to be pulsed with a much higher current than would otherwise be the case when the LEDs are powered with steady state current conditions. This ensures that the maximum amount of light is emitted by the ultraviolet LEDs which in turn ensure a higher amount of light is emitted from the test line and control line.

The LF strip 100 is loaded into the portable device via a strip carrier as previously shown in FIG. 6 with means to retain the LF strip in position on the strip carrier. To disengage the strip carrier from the portable device, a user accesses the navigation controller 510 and depresses one of the buttons when the display asks the user whether they wish to access the strip carrier release mechanism.

In optional arrangements the test strip carrier may be integral with the housing and may be hinged with the housing to enable the LF strip to be loaded onto the test strip carrier. In another arrangement the LF strip may be pushed directly into the housing of the portable device and into a reception slot. The test strip carrier is preferably light proof to ensure that optimum fluorescent emission signal levels are determined, and also to ensure that the portable device is eye-safe as the ultraviolet LEDs may emit light at wavelengths as low as 350 nm which are hazardous to eye safety. The portable device may also contains lockout means to ensure that no ultraviolet light is emitted until an eye-safe condition has been achieved. The LF strip loading means may be movable to a position where the LF strip loading means and the light exit portion of the light guides may be cleaned between assays.

In accordance with any of the embodiments of the invention, an extremely low cost and robust device is able to be produced, which is highly field portable and which does not contain delicate and high cost optical filter sets. An advantage is a device which contains the sensitivity enhancement benefits offered by a fluorescent detection system, but which is simple, field portable, robust, and low in cost.

A further advantage is the ability for the device to communicate with external computing systems, thereby enabling test result data and test metadata communication to remote servers to occur in real time. This advantage addresses the growing need for diagnostic test systems to communicate with electronic medical records databases, which is not presently a feature inherent in LF tests.

A portable device constructed in accordance with the invention, referred to as the FOM (Fluidyx opto-electronic module), underwent several tests. In the first test, the limit of detection capability of the FOM in evaluating Europium labeled LF strips was compared to conventional visual detection of blue-labeled LF strips. In the second test, the sensitivity of the FOM was compared against a conventional laboratory spectrophotometer. Finally, a test was conducted to determine whether the FOM was able to provide a linear response in terms of fluorescence intensity versus bead concentration, and therefore to evaluate the suitability of the FOM as a quantitative diagnostic tool.

For the tests, two analyte sample solutions were prepared. The first sample solution was a dilution series of blue-dyed latex beads, the same beads which are commonly used for visual detection in conventional test strips. A dilution series of these beads was prepared in a buffer at bead concentrations of 0.1%, 0.05%, 0.025%, 0.0125%, 0.00625%, 0.00313%, 0.00157%, and 0.00078%. The second sample solution was a solution of europium-dyed latex beads (suitable for LF strips). A dilution series of these europium beads was also prepared in a buffer at the same concentrations of 0.1%, 0.05%, 0.025%, 0.0125%, 0.00625%, 0.00313%, 0.00157%, and 0.00078%.

Next, on a series of lateral flow membranes, a blue test line was laid down on a number of test strips, spaced 5 mm apart from a europium test line (of exactly the same width as the blue test line). Test strips with side-by-side blue and europium test lines were prepared for each step in the dilution series.

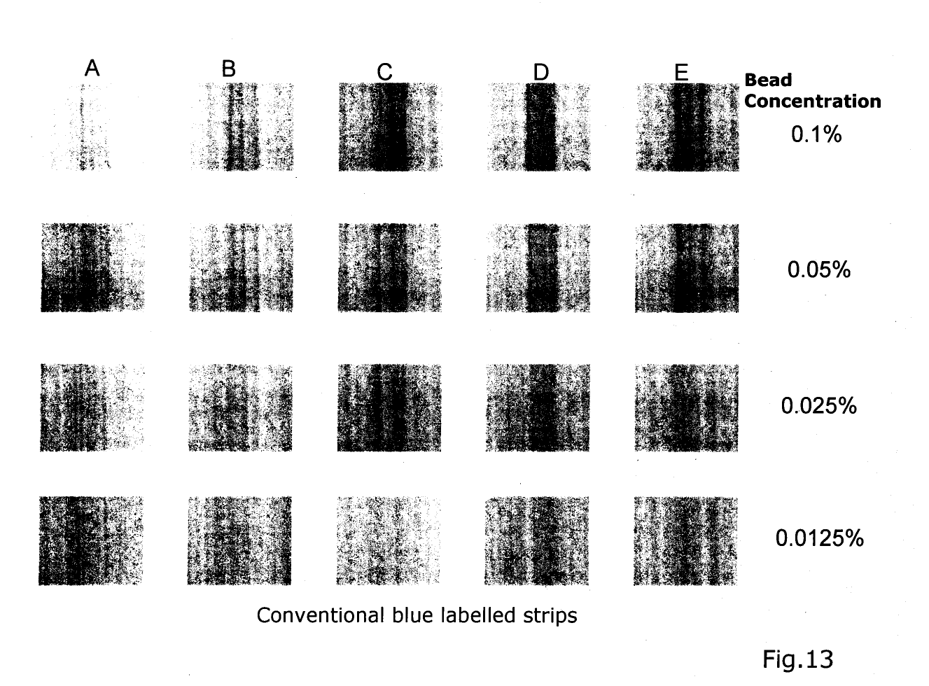

FIG. 13 shows a colour image from a high resolution camera of five of the test strips at four different concentrations, for conventional visual, blue-dyed latex beads. It can be seen that the “Limit of detection” for the blue-dyed latex beads is 0.05% bead concentration. The blue-dyed latex beads at 0.025% concentration are not sufficiently intense to be reliably verified by an operator as a positive test result, and analysis of the test strips at 0.025% in a conventional reflectance photometer indicated that most strips at this bead concentration would be interpreted as “negative” test results.

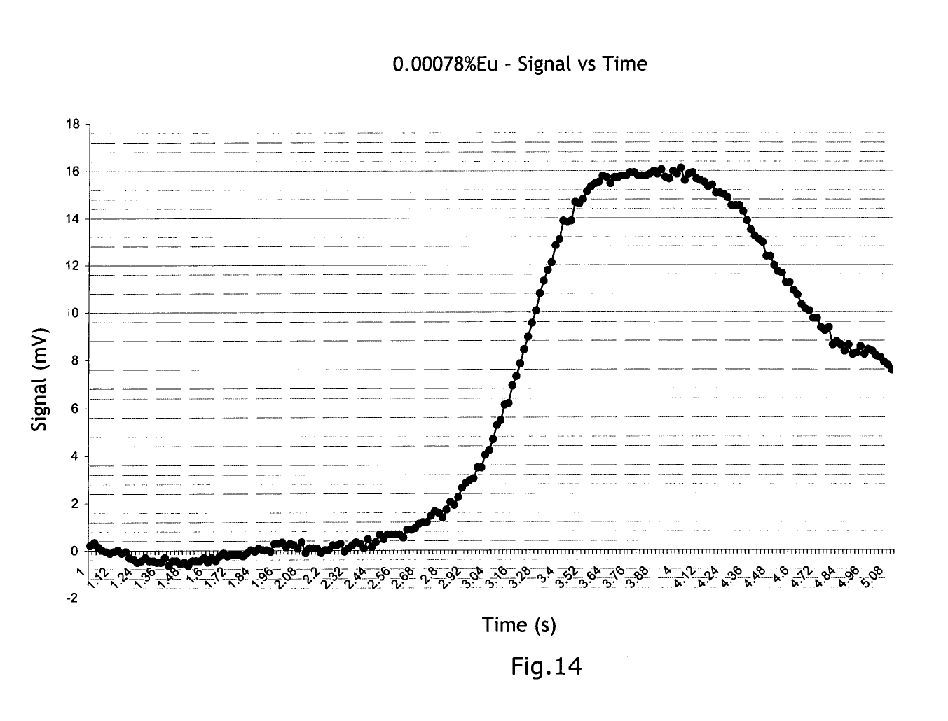

FIG. 14 shows a graph illustrating the results of the FOM scanning a Europium test line at 0.00078% bead concentration. Time gated fluorescence was not used in this test. In the graph, it can be seen that the peak (amplified) test signal reading is approximately 16 mV. The membrane background signal level is approximately 2 mV. Hence the signal to background ratio is approximately 8. Usually, a value of signal to membrane background of 3 is used as the threshold for a positive test. Therefore, the detectability of the Europium test line versus the blue test line is improved by more than 64× when using the FOM with Europium test lines, compared to a conventional visual approach.

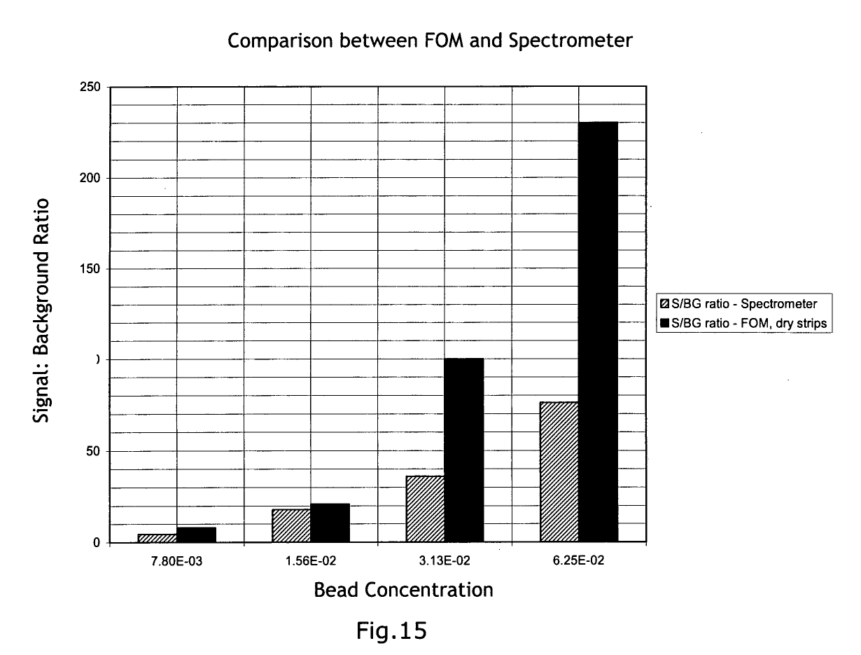

FIG. 15 shows a graph comparing the detectability of the Europium test lines using the FOM to a conventional laboratory spectrophotometer (the Ocean Optics USB-2000FLG). In this graph, the signal to background ratio for the FOM is compared to the conventional spectrophotometer. As illustrated, the FOM gives better results than the laboratory spectrophotometer for the four weakest steps in the dilution series which indicates that it has very good performance as a highly sensitive detection system.

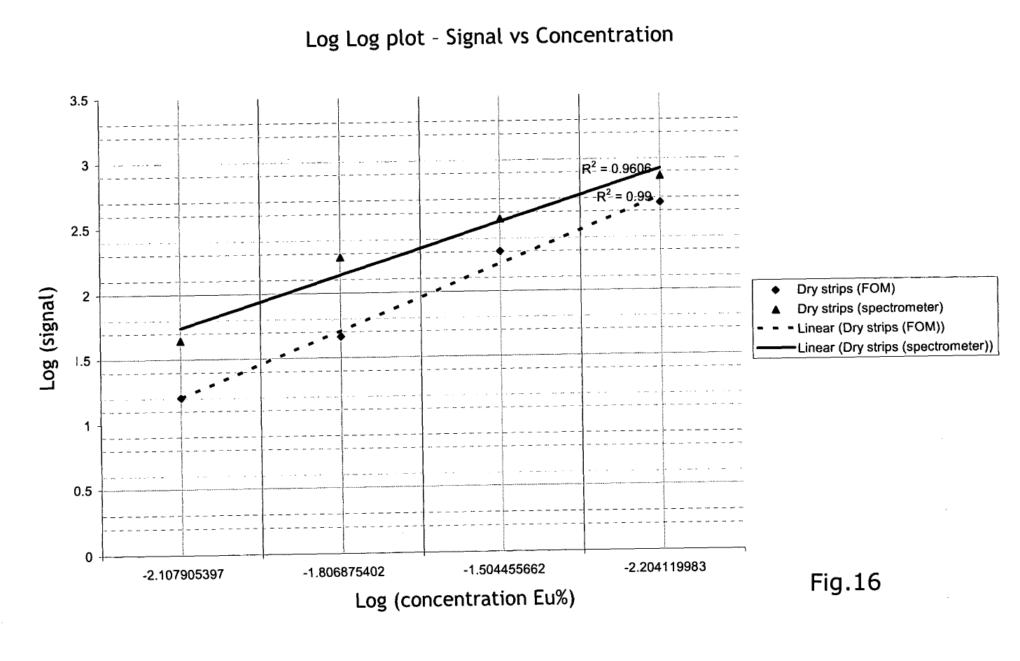

FIG. 16 shows a graph of the linearity of the response of the FOM, in terms of fluorescent response versus bead concentration. The FOM provides highly linear response for the dry strips tested, and the regression coefficient (0.990) is slightly higher than the spectrophotometer (0.9606). This indicates that the FOM has excellent suitability to provide the basis for a low-cost, quantitative diagnostic tool using lateral flow strips with very high sensitivity.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive. For example, whilst the LF strip has been described as having a single test line and single control line, the microprocessor of the first embodiment may include programming to enable the scan of a LF strip having two or more test lines.

In the first embodiment, the transmitting light guide 250 is described as being manufactured from a doped plastic material. In optional embodiments, such filtering means may comprise of a combination of a light guide with particular inherent optical filtering capability laminated or optically bonded to an additional “bandpass” or “lowpass” optical filter. Using either of these approaches, the transmitting light guide 250 acts either as a “bandpass” or “lowpass” filter. Whilst in the first embodiment, the receiving light guide 260 is described as being manufactured from a doped plastic material, alternatively, such filtering means may comprise a combination of a light guide with particular inherent optical filtering capability laminated or optically bonded to an additional “bandpass” or “highpass” filter. Using either of these approaches, the receiving light guide acts either as a “bandpass” or “highpass” optical filter. The optical filtering properties of the transmitting light guide 250 and the receiving light guide 260 work together to ensure that the fluorescence excitation of the LF test is optimised, particularly for narrow Stokes shift fluorophores.

The portable device 200 may further include an optional second long-stroke micro electronic actuator (not shown) to pull the strip carrier 220 or 720 back inside the housing 210 of the portable device 200 for multiple detection passes. This feature could be important for assay applications where it is desired to monitor the level of change in the test and control strip intensity at several time intervals.

In an embodiment where the LF strip is contained in a plastic cassette housing, the plastic cassette housing may be re-designed to perform a double function as the strip carrier as well as the LF strip. In such an embodiment the plastic cassette may also include the resilient foam element, which is a low cost item intended to be disposed with the LF test.

It is anticipated that characteristics of the shape of the curve of the received fluorescence emissions may have significance. For example in the experimental test results depicted in FIG. 9a, a spike, at the trailing edge of the test line 910 can be observed. In time it is anticipated that the chemical significance of this spike or other properties of the curve shape, will be understood, and this information can be used to assist in test result calculation or to provide additional verification of the correct operation of the test and the device.

The portable device in accordance with an embodiment of the invention is additionally operable to read a fluorescent-labelled calibration membrane based assay (a calibration test strip). The calibration strip has multiple lines of known and calibrated emission intensity and curve shape printed on it. The device will automatically detect that this is a calibration strip by the overall format of the captured waveform similar to FIG. 9a but potentially with additional lines and in a known sequence of amplitudes. On acquisition of the test strip waveform, the device can automatically detect that it satisfies the overall characteristics of a calibration strip, and calculate a comprehensive self test and self calibration if required, report its status to the user or to a remote server where the device has an active data connection such as by its USB port. These functions of the device are largely defined in the software routines carried within the device. It is anticipated the software version running within the device can be updated, and maintained by a connected computer or remote server.

In the claims that follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

Further, any reference herein to background art is not intended to imply that such background art forms or formed a part of the common general knowledge.

1. A portable device for reading a fluorescent-labelled, membrane based assay, to detect the presence of an analyte in a sample, the portable device comprising:
a light sealed housing comprising a receiving member to receive a membrane based assay, the light sealed housing including:
a first light source for illuminating a first portion of a membrane with light;
a first photodetector for detecting fluoresced light emitted by an excited fluorescent label captured by a reagent laid down in the first portion of the membrane, and for measuring an intensity of the fluoresced light;
a light guide for guiding illuminated light from the first light source to the first portion of the membrane and for guiding fluoresced light emitted by the excited fluorescent label to the first photodetector; and
a microprocessor operable to process the measured intensity of the fluoresced light to determine whether an analyte is present.

2. A portable device according to claim 1, where the first light source is one of a light emitting diode and a laser diode.

3. A portable device according to claim 1, where the first light source is operable to emit light in the range of 340 nm to 390 nm.

4. (canceled)

5. A portable device according to claim 1, where the light guide includes a transmitting light guide arranged to guide illuminated light from the first light source to the first portion of the membrane and a separate receiving light guide arranged to guide fluorescence light emitted by the excited fluorescent label to an input face of the first photodetector.

6. (canceled)

7. (canceled)

8. A portable device according to claim 5, where the transmitting light guide includes a light receiving surface and a light exiting surface and at least a portion of the light receiving surface is optically coupled to the first light source and the receiving light guide includes a fluoresced light receiving surface and a fluoresced light exiting surface where at least a portion of the fluoresced light exiting surface is optically is optically coupled to the first photodetector.

9. (canceled)

10. A portable device according to claim 8, where the light exiting surface of the transmitting light guide is shaped to substantially conform to the shape of the first portion of the membrane.

11. A portable device according to claim 10, where the light exiting surface of the transmitting light guide is of a rectangular shape having an area of between 5 mm² and 15 mm².

12. (canceled)

13. A portable device according to claim 8, where the transmitting light guide and the receiving light guide are configured such that in use, the respective light exiting surface and fluoresced light receiving surface are positioned proximate a fluorescing surface of the membrane.

14. A portable device according to claim 13, where the transmitting light guide and the receiving light guide are configured such that in use, the respective light exiting surface and fluoresced light receiving surface are positioned between 1 mm and 5 mm from the fluorescing surface of the membrane.

15. A portable device according to claim 1, further comprising a data communication module in communication with the microprocessor to enable data communication between the portable device and a remote device.

16. (canceled)

17. (canceled)

18. A portable device according to claim 1, where the receiving member includes a base and one or more fastening members to releasably fasten the membrane based assay in position on the receiving member.

19. A portable device according to claim 1, where the portable device is operable to scan a fluorescent-labelled, membrane based assay.

20. A portable device according to claim 1, where a retaining member is located within the housing to releasably retain the receiving member in position with respect to the housing.

21. (canceled)

22. (canceled)

23. (canceled)

24. (canceled)

25. (canceled)

26. (canceled)

27. A portable device according to claim 1, further comprising an electronic actuator to enable multiple scans of the membrane based assay.

28. A portable device according to claim 27, where the first photodetector further detects fluoresced light emitted by an excited fluorescent label captured by a control reagent laid down in a second portion of the membrane and to measure an intensity of the fluoresced light, where the second portion of the membrane is downstream from the first portion of the membrane.

29. A portable device according to claim 28, where the microprocessor is operable to normalise the intensity of the fluoresced light from the first portion of the membrane and from the second portion of the membrane, to compensate for variations in the rate of transport.

30. A portable device according to claim 29, where the microprocessor is further operable to compare a ratio of the intensity of the fluoresced light from the first portion of the membrane to the measured intensity of the fluoresced light from the second portion of the membrane, against data stored in memory, to determine whether quality control parameters have met pre-determined specifications.

31. A portable device according to claim 1, where the portable device further includes signal processing means connected to the first photodetector and the microprocessor.

32. A portable device according to claim 31, where the signal processing means comprises:
a variable gain amplifier connected to an output of the first photodetector; and
a feedback circuit connected to the variable gain amplifier for controlling the gains thereof.

33. A portable device according to claim 32, where the microprocessor monitors a signal representative of the measured intensity to determine if a saturation condition exists.

34. A portable device according to claim 33, where the microprocessor is further operable to produce a gain control signal for reducing the gain of the variable gain amplifier if a saturation condition exists.

35. A portable device according to claim 1, further comprising a display for displaying diagnostic results from an assay, where the diagnostic result is at least one of a qualitative result and a quantitative result.

36. A portable device according to claim 1, where the light source is a pulsed light source and the first photodetector is a time gated photodetector.

37. A portable device according to claim 36, where the microprocessor includes timing circuitry in communication with the first light source and the time-gated photodetector to control pulsed excitation and photodetection.

38. A portable device according to claim 37, where the microprocessor and timing circuitry is operable to:
(i) direct the first light source to turn on;
(ii) direct the first light source to turn off after a first time period; and
(iii) measure the intensity of the fluoresced light after a second time period measured from when the light source is directed to turn off.

39. A portable device according to claim 36, where the portable device further comprises a second light source for illuminating a second portion of the membrane downstream from the first portion of the membrane, and a second photodetector for detecting fluoresced light emitted by an excited fluorescent label captured by a second reagent laid down in the second portion of the membrane.

40. A portable device according to claim 39, where the portable device further comprises a second light guide for guiding illuminated light from the second light source to the second portion of the membrane and for guiding fluoresced light emitted by the excited fluorescent label to the second photodetector.

41. (canceled)
